(19) United States
(12) Patent Application Publication
(10) Pub. No.: US 2009/0109826 A1
(43) Pub. Date: Apr. 30, 2009

(54) OPTICAL PICKUP AND OPTICAL INFORMATION STORAGE MEDIUM SYSTEM EMPLOYING THE OPTICAL PICKUP

(75) Inventors: Kyongtae PARK, Suwon-si (KR); Tae-kyung KIM, Seoul (KR); Jae-cheol BAE, Suwon-si (KR)

Correspondence Address: STEIN, MCEWEN & BUI, LLP, 1400 EYE STREET, NW, SUITE 300, WASHINGTON, DC, 20005, US

(73) Assignee: SAMSUNG ELECTRONICS CO., LTD., Suwon-si (KR)

(21) Appl. No.: 12/117,227

(22) Filed: May 8, 2008

(30) Foreign Application Priority Data
Oct. 30, 2007 (KR) 2007-109676

(51) Int. Cl. G11B 7/00

(52) U.S. Cl. 369/112.23

(57) ABSTRACT

An optical pickup and a recording and/or reproducing apparatus having the same, the optical pickup including: a light source emitting a light beam; an objective lens focusing the emitted light beam onto a multi-layered optical information storage medium; a polarization dependent optical path changer changing a proceeding path of the light beam; a photodetector detecting a signal beam reflected from the optical information storage medium; and a polarization element provided on an optical path of the reflected signal beam, and reducing interference between the signal beam and a noise beam reflected from an adjacent layer on a light receiving plane by changing a polarization state of the signal beam in at least a portion where the signal beam overlaps with the noise beam.

### CROSS-REFERENCE TO RELATED APPLICATION

This application claims the benefit of Korean Patent Application No. 2007-109676, filed Oct. 30, 2007 in the Korean Intellectual Property Office, the disclosure of which is incorporated herein by reference.

### BACKGROUND OF THE INVENTION

1. Field of the Invention

Aspects of the present invention relate to an optical pickup applicable to a multilayer optical information storage medium and an optical information storage medium system employing the optical pickup.

2. Description of the Related Art

Data is recorded and/or reproduced to/from optical information storage media (such as optical discs) by using an optical recording and/or reproducing apparatus that uses a laser beam having a different wavelength and an objective lens having a different numerical aperture (NA) according to the amount of data to be stored. That is, as the amount of data to be stored in an optical disc increases, a light source having a shorter wavelength and an objective lens having a higher NA are used. For example, a compact disc (CD) uses a light beam having a 780 nm wavelength and an objective lens having a 0.45 NA. A digital versatile disc (DVD) usually uses a light beam having a 650 nm wavelength and an objective lens having a 0.6 NA. A Blu-ray disc (BD) usually uses a light beam having a 405 nm wavelength and an objective lens having a 0.85 NA.

In other words, the recording capacity in an optical recording and/or reproducing apparatus that records and/or reproduces data to/from an optical disc using an optical spot obtained by focusing a laser beam with an objective lens is inversely proportional to the size of the optical spot due to the focusing. Also, the size S of a focused spot is determined by the wavelength λ of a laser beam being used and the NA of an objective lens, as given by Equation 1:

S∝k*λ/NA,

where k is a constant dependent on an optical system and is usually a value between 1-2.

Accordingly, in order to increase the density of an optical disc, the size S of the optical spot formed on the optical disc must be decreased. To decrease the size S of the optical spot, the wavelength λ of a laser beam needs to be decreased or the NA needs to be increased as shown in Equation 1.

However, high priced parts are needed to decrease the wavelength λ of a laser beam. Also, when the NA of an objective lens is increased, a focal depth decreases by the square of the NA and coma aberration increases by the cube of the NA. Thus, there is a limit in increasing the density of an optical disc by reducing the size S of the optical spot using the above-described methods.

Although DVDS, high definition DVDs (HD-DVDs), and BDs are high density recording media having a high recording capacity as compared to conventional optical discs, there is a continuous demand for an increase in the recording capacity of optical discs. Thus, multilayer optical discs having two or more recording layers on one or both sides of a disc are used in order to drastically increase the recording capacity of an optical disc.

That is, a multilayer optical disc is used to increase the recording capacity of the optical recording and/or reproducing apparatus. However, in this case, light beams reflected from a layer adjacent to a recording and/or reproducing layer interfere with a signal beam so as to generate noise.

A differential push-pull (DPP) method that can correct an offset of a push-pull signal generated during the reproduction of an eccentric optical disc is generally employed as a tracking method of a recordable optical disc. According to the DPP method, a light beam is generally split into three light beams of a 0^{th} order light beam (a main light beam) and ±1^{st} order light beams (sub-light beams) by using a grating. The ratio of the amount of light of the split light beams (that is, −1^{st} order: 0^{th} order: +1^{st} order) is roughly 1:10:1 depending on a light use efficiency.

When the DPP method is used to detect a tracking error signal from a multilayer optical disc having a plurality of recording layers (for example, a dual layer optical disc having two recording layers), the tracking error signal is degraded when the 0^{th} order light beam reflected from the adjacent layer overlaps with the ±1^{st} order light beams reflected from the recording and/or reproducing layer. That is, although the difference in the amount of light between the 0^{th} order light beam reflected from the recording and/or reproducing layer and the 0^{th} order light beam reflected from the adjacent layer is very large, the difference in the amount of light between the ±1^{st} order light beams reflected from the recording and/or reproducing layer and the 0^{th} order light beam reflected from the adjacent layer is relatively low. As a result, the 0^{th} order light beam of the adjacent layer considerably affects a differential signal (i.e., a sub-push-pull (SPP) signal to the sub-light beam) used for detecting the tracking error signal in the DPP method.

In order to prevent the SPP signal from being unstable due to an interlayer interference beam, a one-beam tracking method of using a main light beam only, as opposed to using sub-light beams, has been disclosed in Japanese Patent Publication No. 2006-054006. However, in the one-beam tracking method, a signal light having a large amount of light is not free from interlayer interference. When a multilayer optical disc is implemented, an interlayer interval is further decreased, and thus, the push-pull detection signal with respect to the main light beam (i.e., a main push-pull (MPP) signal) is further deteriorated. Thus, there is a need for a method of improving the MPP signal deterioration in the multilayer optical disc.

### SUMMARY OF THE INVENTION

Aspects of the present invention provide an optical pickup that improves a signal to noise ratio (SNR) by weakening an interference generated between a signal beam reflected from a recording and/or reproducing layer of a multilayer optical information storage medium having a short interlayer interval and a noise beam reflected from an adjacent layer, and thus, simultaneously performs tracking with only one light beam, and an optical information storage medium system employing the optical pickup.

According to an aspect of the present invention, there is provided an optical pickup of a recording and/or reproducing apparatus that records and/or reproduces data to/from a multi-layer optical information storage medium, the optical pickup including: a light source to emit a light beam; an objective lens to focus the emitted light beam onto the optical information storage medium; a polarization dependent optical path changer to change a proceeding path of the light beam according to a polarization of the light beam; a photodetector to detect a signal beam that is generated by a reflection of the focused light beam on a signal layer of the optical information storage medium; and a polarization element provided on an optical path of the signal beam reflected from the optical information storage medium, passing through the objective lens, and proceeding toward the photodetector, to reduce an interference, on a light receiving plane, between the signal beam and a noise beam that is generated by a reflection of the light beam from an adjacent layer to the signal layer by changing a polarization state of the signal beam in at least a portion where the signal beam overlaps with the noise beam.

The polarization element may include a polarization change area to change a polarization of a central portion of the signal beam, and the polarization change area may be a half wave plate or a random polarizer.

The signal beam may be diffracted from the optical information storage medium into a 0^{th} order diffractive beam, a −1^{st} diffractive beam, and a +1^{st} diffractive beam, and may include a first overlap area where the 0^{th} order diffractive beam and the +1^{st} order diffractive beam overlap, a second overlap area where the 0^{th} order diffractive beam and the −1^{st} order diffractive beam overlap separately from the first overlap area, and a non-overlap area formed of the 0^{th} order diffractive beam, and the polarization element changes the polarization of a light beam passing through an area corresponding to the central portion of the non-overlap area of the signal beam.

The polarization element may include a polarization change area in the area corresponding to the central portion of the non-overlap area of the signal beam to change the polarization of the 0^{th} order diffractive beam passing therethrough, and the polarization change area may be a half wave plate or a random polarizer.

The photodetector may include: a first light receiving portion to detect the central portion of the non-overlap area of the signal beam; a second light receiving portion to detect the first overlap area; a third light receiving portion to detect the second overlap area; fourth and fifth light receiving portions to detect a first remaining portion of the signal beam at a side of the first through third light receiving portions such that the first remaining portion of the signal beam is divided into two sections by a first separation line; and sixth and seventh light receiving portions to detect a second remaining portion of the signal beam at another side of the first through third light receiving portions such that the second remaining portion of the signal beam is divided into two parts by a second separation line aligned with the first separation line, wherein the second light receiving portion, the fourth light receiving portion, and the sixth light receiving portion are arranged in a first row and the third, fifth, and seventh light receiving portions are arranged in a second row.

The second and third light receiving portions may be respectively divided into two sections by third and fourth separation lines crossing the first and second separation lines so that the photodetector has a nine-sectioned structure.

The first light receiving portion may be divided into four sections by a separation line joining the first and second separation lines and a separation line joining the third and fourth separation lines.

A width of the first light receiving portion in a linear arrangement direction may be less than widths of the second and third light receiving portions.

A width of the first light receiving portion in a linear arrangement direction may be equal to or greater than widths of the second and third light receiving portions.

According to another aspect of the present invention, there is provided an optical information storage medium system including: a spindle motor to rotate an optical information storage medium; the above optical pickup provided to be moveable in a radial direction of the optical information storage medium to record and/or reproduce data to/from the optical information storage medium; a driving portion to drive the spindle motor and the optical pickup; and a control portion to control focus and track servo of the optical pickup.

According to another aspect of the present invention, there is provided an optical information storage medium system including: the above optical pickup to record and/or reproduce data to/from the optical information storage medium; and a tracking error signal detection portion to detect a tracking error signal from a detection signal of the photodetector of the optical pickup, the tracking error signal detection portion including: a first operation unit to detect a first differential signal between detection signals of the second and third light receiving portions, a second operation unit to detect a second differential signal between a sum signal of detection signals of the fourth and sixth light receiving portions and a sum signal of detection signals of the fifth and seventh light receiving portions, and a third operation unit to detect a differential signal between the first and second differential signals obtained from the first and second operation units to generate the tracking error signal.

The optical information storage medium system may further include a reproduction signal detection portion to detect an information reproduction signal by summing detection signals of the first through seventh light receiving portions.

According to another aspect of the present invention, there is provided an optical information storage medium system including: the above optical pickup to record and/or reproduce data to/from the optical information storage medium; and a first tracking error signal detection portion to detect a tracking error signal from a detection signal of the photodetector of the optical pickup, the first tracking error signal detection portion including: a first operation unit to detect a first differential signal between detection signals of the second and third light receiving portions, a second operation unit to detect a second differential signal between a sum signal of detection signals of the fourth and sixth light receiving portions and a sum signal of detection signals of the fifth and seventh light receiving portions, and a third operation unit to detect a differential signal between the first and second differential signals obtained from the first and second operation units to generate a first tracking error signal.

The optical information storage medium system may further include a second tracking error signal detection portion to detect a second tracking error signal from a detection signal of the photodetector of the optical pickup, wherein the second tracking error signal detection portion detects a differential phase signal from a sum signal of detection signals of one of the split areas of the second light receiving portion and the fourth light receiving portion adjacent to the one of the split areas of the second light receiving portion, a sum signal of detection signals of the other one of the split areas of the second light receiving portion and the sixth light receiving portion adjacent to the other one of the split areas of the second light receiving portion, a sum signal of detection signals of one of the split areas of the third light receiving portion and the fifth light receiving portion adjacent to the one of the split areas of the third light receiving portion, and a sum signal of detection signals of the other one of the split areas of the third light receiving portion and the seventh light receiving portion adjacent to the other one of the split areas of the third light receiving portion.

The optical information storage medium system may further include a reproduction signal detection portion to detect an information reproduction signal by summing detection signals of the first through seventh light receiving portions.

According to another aspect of the present invention, there is provided an optical information storage medium system including: an optical pickup to record and/or reproduce data to/from the optical information storage medium; a first tracking error signal detection portion to detect a first tracking error signal from a detection signal of the photodetector of the optical pickup; and a reproduction signal detection portion to detect an information reproduction signal, wherein the first tracking error signal detection portion includes: a first operation unit to detect a first differential signal between detection signals of the second and third light receiving portions, a second operation unit to detect a second differential signal between a sum signal of detection signals of the fourth and sixth light receiving portions and a sum signal of detection signals of the fifth and seventh light receiving portions, and a third operation unit to detect a differential signal between the first and second differential signals obtained from the first and second operation units to generate the first tracking error signal, and the reproduction signal detection portion detects an information reproduction signal by summing the detection signals of the first through seventh light receiving portions.

The optical information storage medium system may further include a focus error signal detection portion to detect a focus error signal from detection signals of one of the split areas of the second light receiving portion and the fourth light receiving portion adjacent to the one of the split areas of the second light receiving portion, detection signals of the other one of the split areas of the second light receiving portion and the sixth light receiving portion adjacent to the other one of the split areas of the second light receiving portion, detection signals of one of the split areas of the third light receiving portion and the fifth light receiving portion adjacent to the one of the split areas of the third light receiving portion, and detection signals of the other one of the split areas of the third light receiving portion and the seventh light receiving portion adjacent to the other one of the split areas of the third light receiving portion.

The optical information storage medium system may further include a second tracking error signal detection portion to detect a differential phase signal using the detections signals of the second through seventh light receiving portions used for detecting the focus error signal.

The optical information storage medium system may further include first through fourth adders to obtain a first sum signal of the detection signals of one of the split areas of the second light receiving portion and the fourth light receiving portion adjacent to the one of the split areas of the second light receiving portion, a second sum signal of the detection signals of the other one of the split areas of the second light receiving portion and the sixth light receiving portion adjacent to the other one of the split areas of the second light receiving portion, a third sum signal of the detection signals of one of the split areas of the third light receiving portion and the fifth light receiving portion adjacent to the one of the split areas of the third light receiving portion, and a fourth sum signal of the detection signals of the other one of the split areas of the third light receiving portion and the seventh light receiving portion adjacent to the other one of the split areas of the third light receiving portion, and at least one of the information reproduction signal, the focus error signal, and the differential phase signal (for example, only the information reproduction signal, or the information reproduction signal and the focus error signal) is detected using the first through fourth sum signals.

According to another aspect of the present invention, there is provided an optical information storage medium system including: the optical pickup as described above to record and/or reproduce data to/from the optical information storage medium; a first tracking error signal detection portion to detect a first tracking error signal from a detection signal of the photodetector of the optical pickup; a reproduction signal detection portion to detect an information reproduction signal; and a focus error signal detection portion to detect a focus error signal, wherein the first tracking error signal detection portion includes: a first operation unit to detect a first differential signal between detection signals of the second and third light receiving portions; a second operation unit to detect a second differential signal between a sum signal of detection signals of the fourth and sixth light receiving portions and a sum signal of detection signals of the fifth and seventh light receiving portions; and a third operation unit to detect a differential signal between the first and second differential signals obtained from the first and second operation units to generate the first tracking error signal, the reproduction signal detection portion detects an information reproduction signal by summing the detection signals of first through seventh light receiving portions, and the focus error signal detection portion detects a focus error signal from the detection signals of one of the split areas of the second light receiving portion, the fourth light receiving portion adjacent to the one of the split areas of the second light receiving portion, and a split area of the first light receiving portion adjacent to the one of the split areas of the second light receiving portion and the fourth light receiving portion, the detection signals of the other one of the split areas of the second light receiving portion, the sixth light receiving portion adjacent to the other one of the split areas of the second light receiving portion, and a split area of the first light receiving portion adjacent to the other one of the split areas of the second light receiving portion and the sixth light receiving portion, the detection signals of one of the split areas of the third light receiving portion, the fifth light receiving portion adjacent to the one of the split areas of the third light receiving portion, and a split area of the first light receiving portion adjacent to the one of the split areas of the third light receiving portion and the fifth light receiving portion, and the detection signals of the other one of the split areas of the third light receiving portion, the seventh light receiving portion adjacent to the other one of the split areas of the third light receiving portion, and a split area of the first light receiving portion adjacent to the other one of the split areas of the third light receiving portion and the seventh light receiving portion.

According to another aspect of the present invention, there is provided an optical pickup of a recording and/or reproducing apparatus including an objective lens and a photodetector to record and/or reproduce data to/from a multi-layer optical information storage medium, the optical pickup including: a polarization element provided on an optical path of a signal beam reflected from the optical information storage medium, passing through the objective lens, and proceeding toward the photodetector, to reduce an interference, on a light receiving plane, between the signal beam and a noise beam that is generated by a reflection from an adjacent layer to the signal layer by changing a polarization state of the signal beam in at least a portion where the signal beam overlaps with the noise beam.

According to another aspect of the present invention, there is provided a method of reducing an interference between a signal beam reflected from a signal layer of a multi-layer optical information storage medium and a noise beam reflected from an adjacent layer to the signal layer in a recording and/or reproducing apparatus including an objective lens and a photodetector to record and/or reproduce data to/from the multi-layer optical information storage medium, the method including: changing a polarization state of the signal beam, after being reflected from the signal layer and before being detected by the photodetector, in at least a portion of the signal beam where the signal beam overlaps with the noise beam.

As described above, according to the optical pickup according to the present invention and the optical information storage medium system, by reducing the interference generated between the signal beam reflected from the recording/reproduction layer of a multilayer optical information storage medium having a short interlayer interval and the noise beam reflected from the other layer, an SNR is improved and simultaneously tracking is performed with only one beam.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates an optical configuration of an optical pickup according to an embodiment of the present invention;

FIG. 2 illustrates the structure of a polarization element of FIG. 1 and the shape of a beam formed on a light receiving surface after the beam passes through the polarization element;

FIG. 3 illustrates the structure of a photodetector and a signal detection circuit according to an embodiment of the present invention;

FIG. 4 illustrates the structure of a photodetector and a signal detection circuit according to another embodiment of the present invention;

FIG. 5 illustrates the structure of a photodetector and a signal detection circuit according to still another embodiment of the present invention; and

FIG. 6 illustrates the overall structure of an optical information storage medium system employing the optical pickup according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

A field of a signal beam reflected from an optical information storage medium (such as an optical disc) and incident on a light receiving portion can be defined as Equation 2:

Eₛ=Aₛexp[−i(ω₀t+φₛ)],

where Aₛ is the field amplitude of the signal beam, Eₛ is the field of the signal beam, and φₛ is the phase of the signal beam.

A noise beam reflected from another layer and incident on the light receiving portion can be defined as Equation 3:

Eₙ=Aₙexp[−i(ω₀t+φₙ)],

where Aₙ is the field amplitude of the noise beam, Eₙ is the field of the noise beam, and φₙ is the phase of the noise beam.

The intensity P of the light when the signal beam and the noise beam are combined can be defined as Mathematical Equation 4:

P=|Eₛ+Eₙ|².

Equation 5 shows an intensity P(t) according to time when the signal beam and the noise beam are combined:

P(t)=Pₛ+Pₙ+2i \sqrt{PₛPₙ} cos(φₛ−φₙ)cos θ,

where Pₛ is the magnitude of the intensity of the signal beam, and Pₙ is the magnitude of the intensity of the noise beam. According to Equation 5, when the polarizations of the signal beam and the noise beam are matched, the value of cos θ is maximized. The value of Equation 5 varies according to a change in phase difference generated between the signal beam and the noise beam.

As shown in Equation 5, when the noise beam interferes with the signal beam even when the absolute size of the noise beam reflected from the other layer is small, a DC fluctuation of a low frequency wave is generated. For example, assuming that the amount of the signal beam is 100% and the amount of the noise beam is 1%, although the absolute amount of the noise beam is negligibly small as compared to that of the signal beam, the amount of an interference beam is 2\sqrt{100*1} cos(φₛ−φₙ), and increased by about 20% at its maximum (when cos θ=1). The interference beam, which is a DC fluctuation component of a low frequency wave, causes deterioration of a tracking signal that has a lower frequency wave component than a reproduction signal (i.e., an RF signal). The interference between the signal beam and the noise beam reflected from the other layer is referred to as an interlayer interference. A noise component generated by the interlayer interference is referred to as an interlayer interference noise.

In a differential push-pull (DPP) method, which is a general tracking method for a land/groove type optical information storage medium, the interlayer interference noise greatly affects a sub-push-pull (SPP) signal having the amount of a signal beam, which is smaller than that of a main push-pull (MPP) signal. This is because when the SPP signal is amplified by k times to remove a DC offset component of a tracking error signal, the interlayer interference noise is also amplified by k times so that the DC fluctuation is directly applied to the overall DPP signal.

To stabilize the tracking signal due to the interlayer interference, the conventional method of using one beam, as disclosed in Japanese Patent Publication No. 2006-054006, excludes the use of the SPP signal with respect to the interlayer interference so that the stability of the tracking signal can be improved. However, since the MPP signal is also affected by the interlayer interference, the method is not free from the interlayer interference. When a multilayer optical information storage medium is implemented, the interlayer interval may be further decreased. As the interlayer interval decreases, the MPP signal is further degraded.

Equation 6 relates the intensity of the signal beam and the noise beam according to the time when the signal layer is inserted between the adjacent layers:

P(t)=Pₛ+Pₙ₁+Pₙ₂+2\sqrt{PₛPₙ₁} cos(φₛ−φₙ₁)cos θ+2\sqrt{PₛPₙ₂} cos(φₛ−φₙ₂)cos θ+2\sqrt{Pₙ₁Pₙ₂} cos(φₙ₁−φₙ₂)cos θ+ . . . ,

where Pₙ₁ and Pₙ₂ are the intensity of the noise beam generated respectively by first and second adjacent layers located, for example, in front of and at the back of the signal layer (the recording and/or reproducing layer), and φₙ₁ and φₙ₂ are the phase of the noise beam generated respectively by the first and second adjacent layers. As the number of the recording layers formed on one side of the optical information storage medium increases, interlayer interference noise increases and the number of interlayer interference noise components increases.

In an optical information storage medium system according to aspects of the present invention, a more stable one-beam tracking method may be provided by not only excluding the use of the SPP signal but also removing the interlayer interference affecting the MPP signal.

As an example, a dual-layer optical information storage medium has two layers L1 and L0 to increase a storage density, where the second layer L1 is closer to a light incident surface of the optical information storage medium and the first layer L0 is farther from the light incident surface. Furthermore, the first layer L0 has a reflection amount of 30% and a transmission amount of 70% while the second layer L1 has a reflection amount of 95% and a transmission amount less than 5%. Due to this disc's characteristics, during the recording and/or reproducing of the second layer L1, a light beam passing through the second layer L1 is defocused at the first layer L0 to thus form an amount of light reflection. In contrast, during the recording and/or reproducing of the first layer L0, an amount of light reflection defocused at the second layer L1 occurs. The light reflected by the adjacent layer is received on a photodetector by being defocused in a light spot that is increased in size. When the light spreads as the light spot size due to reflection from the adjacent layer increases, the signal beam is relatively less affected by the defocused light reflection. When the light spot size of the light beam due to reflection from the adjacent layer decreases, however still larger than that of the signal beam, the signal beam is relatively more affected by the defocused light reflection.

For the present dual optical digital versatile disc (DVD), since the interlayer interval is sufficiently distant, the light reflection of the adjacent layer is defocused and formed to a relatively large size on the photodetector. Thus, the signal beam is not greatly affected. However, for a higher density optical information storage medium (such as a Blu-ray disc (BD)), the numerical aperture (NA) of an objective lens is increased. To do so, the thickness of the optical information storage medium is adjusted to prevent performance degradation due to the inclination of the optical information storage medium. Specifically, the thickness of the optical information storage medium may be reduced to about 0.1 mm.

Also, when the high density optical information storage medium has a plurality of recording layers, the interlayer interval is roughly determined in proportion to the depth of a focus. Since the focal depth is proportional to λ/NA², the interlayer interval of a DVD dual optical disc is about 55 μm. For a BD, the interlayer interval is much less than that of the DVD (i.e., less than about half of the interlayer interval of the DVD). Also, as the number of the recording layers deposited on one side increases, the interlayer interval is further decreased.

Thus, when the optical information storage medium having a higher density than the DVD is configured to have a plurality of recording layers (for example, two or four layers), since the interlayer interval is relatively short, the light reflection of the adjacent layer is formed on the photodetector in a size smaller than that of the DVD and, thus, may greatly affect a reproduction signal beam.

Aspects of the present invention are based on a principle that as the size component of the interference beam decreases in Equation 5 or 6 above, the noise beam from the adjacent layer decreasingly affects the signal beam. When the polarizations of the signal beam and the noise beam change, the value of cos θ in the size component of the interference beam in Equation 5 or 6 changes accordingly. Thus, if the optical system is configured to reduce the value of cos θ, the effect of the noise beam on the signal beam can be reduced.

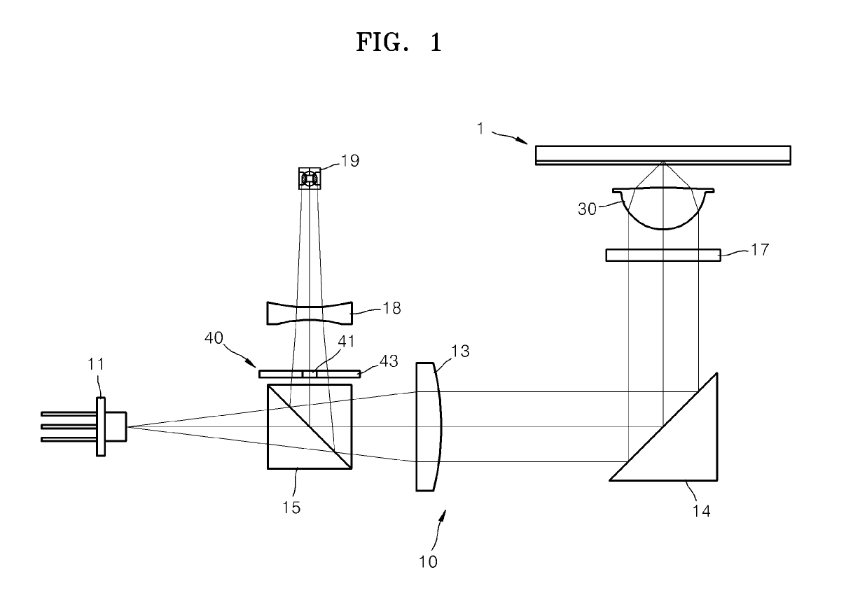

FIG. 1 illustrates an optical configuration of an optical pickup 10 according to an embodiment of the present invention. Referring to FIG. 1, the optical pickup 10 includes a light source 11, an objective lens 30, a polarization dependent optical path changer, a photodetector 19, and a polarization element 40. The light source 11 emits a light beam of a predetermined wavelength. The objective lens 30 focuses an incident beam on an optical information storage medium 1 having a plurality of recording layers. The polarization dependent optical path changer changes a proceeding path of the incident beam. The photodetector 19 receives a light beam reflected from the optical information storage medium 1. The polarization element 40 reduces an interference between a signal beam and a light beam reflected from an adjacent layer (i.e., a noise beam) on a light receiving plane.

The optical pickup 10 further includes a collimating lens 13 provided on an optical path between the light source 11 and the objective lens 30 to collimate divergent beams emitted from the light source 11 into parallel beams. In FIG. 1, the collimating lens 13 is arranged between a polarization beam splitter 15 of the polarization dependent optical path changer and the objective lens 30. A detection lens 18 is further provided on the optical path between the polarization dependent optical path changer and the photodetector 19 to allow the light beam reflected from the optical information storage medium 1 to be received by the photodetector 19 in an appropriate optical spot size. The detection lens 18 may be an astigmatism lens to detect a focus error signal in an astigmatism method. Furthermore, in the optical pickup 10 illustrated in FIG. 1, a mirror 14 changes the optical path of a light beam.

The light source 11 is provided to generate and emit a laser beam having a wavelength appropriate for the type of the optical information storage medium 1. For example, a semiconductor laser emitting a light beam in a blue wavelength range (such as a light beam of an about 405 nm wavelength) that satisfies BD or HD-DVD standards can be used as the light source 11.

The objective lens 30 is provided to achieve a NA appropriate for the type of the optical information storage medium 1. For example, when the optical information storage medium 1 is a BD, the objective lens 30 may be provided to achieve a NA of 0.85. When the optical information storage medium 1 is a HD-DVD, the objective lens 30 may be provided to achieve an NA of 0.65. Also, for example, when a BD or HD-DVD is compatibly adopted, the objective lens 30 may be provided to achieve effective NAs of 0.85 and 0.65 or an effective NA of 0.85. When the objective lens 30 is provided to achieve an effective NA of 0.85, an additional member (not shown) can be further provided to adjust NA.

The polarization dependent optical path changer is arranged on an optical path between the light source 11 and the objective lens 30 to change the proceeding path of the incident beam. The polarization dependent optical path changer includes the polarization beam splitter 15 and a quarter wave plate 17. However, it is understood that according to other aspects, different or additional components may be used as the polarization dependent optical path changer to change the proceeding path of the incident beam. The polarization beam splitter 15 transmits or reflects an incident beam according to the polarization of the incident beam. The quarter wave plate 17 changes the polarization of the incident beam. In the optical pickup 10 illustrated in FIG. 1, a light beam of one polarization emitted from the light source 11 passes through the polarization beam splitter 15 and proceeds toward the optical information storage medium 1. In contrast, the light beam reflected from the optical information storage medium 1 is reflected from the polarization beam splitter 15 and received by the photodetector 19. The quarter wave plate 17 changes a light beam of a first linear polarization output from the polarization beam splitter 15 to a light beam of a first circular polarization, and changes a light beam of a second circular polarization, different from the first circular polarization, reflected from the optical information storage medium 1 to a light beam of a second linear polarization perpendicular to the first linear polarization. The light beam of the first circular polarization changes to the light beam of the second circular polarization when reflected from the optical information storage medium 1.

When the optical path changer is configured as a polarization dependent type, the light beam reflected from the optical information storage medium 1, passing through the optical path changer, and proceeding toward the photodetector 19 along the optical path becomes the light beam of a particular polarization (for example, the second linear polarization).

The polarization element 40 reduces interference between the signal beam and the noise beam on a light receiving plane (such as the surface of the photodetector 19) by changing the polarization state of the light in at least a part of a portion where the signal beam overlaps with the light beam reflected from the adjacent layer. The polarization element 40 is arranged on the optical path of the signal beam reflected from recording and/or reproducing layer of the optical information storage medium 1, passing through the objective lens 30, and proceeding toward the photodetector 19.

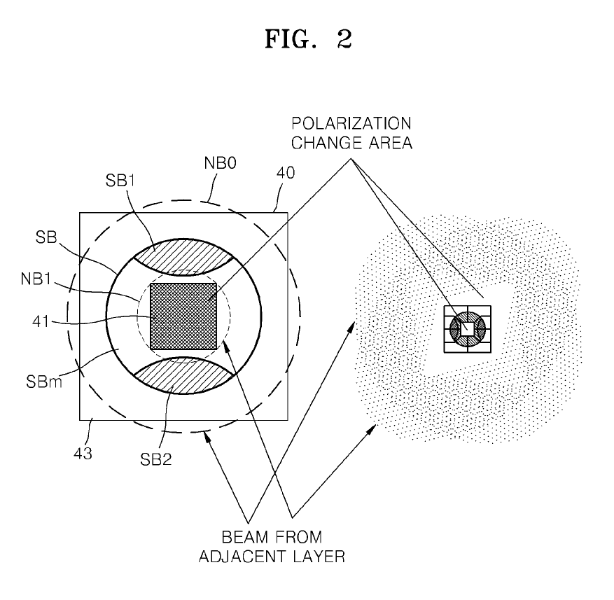

FIG. 2 illustrates the structure of the polarization element 40 of FIG. 1 and the shape of a beam formed on the light receiving plane (such as the surface of the photodetector 19) after the beam passes through the polarization element 40. The shape of the beam of FIG. 2 shows the distribution of a beam incident on the polarization element 40 and the light receiving plane when the adjacent layer is located before or far from the signal layer (i.e., the recording and/or reproducing layer). Referring to FIG. 2, when a signal beam SB is reflected from the optical information storage medium 1, the signal beam SB is diffracted to a 0^{th} order diffractive beam, a −1^{st} order diffractive beam, and a +1^{st} order diffractive beam. The signal beam SB reflected from the optical information storage medium 1 includes a first overlap area SB1 where the 0^{th} order diffractive beam and the +1^{st} order diffractive beam overlap, a second overlap area SB2 where the 0^{th} order diffractive beam and the −1^{st} order diffractive beam overlap separately from the first overlap area SB1, and a non-overlap area SBm formed of the 0^{th} order diffractive beam only.

In the polarization element 40, a noise beam NB0 that is larger than the signal beam SB is reflected from the adjacent layer located in front of the signal layer, and a noise beam NB1 that is smaller than the signal beam SB is reflected from the adjacent layer located at the rear of the signal layer.

The polarization element 40 includes a polarization change area 41 at the center portion of the polarization element 40 to change the polarization of a light beam passing through an area corresponding to the central area of the non-overlap area SBm of the signal beam. The polarization element 40 further includes a polarization non-change area 43 located outside of the polarization change area 41 in the polarization element 40 and formed of a general transparent material to transmit an incident light without changing a polarization thereof. According to other aspects, the polarization element 40 may include only the polarization change area 41.

The polarization change area 41 changes the polarization of a light beam passing therethrough to be different from the polarization of a light beam passing through the non-change area 43. The polarization change area 41 may be formed of a half wave plate. In this case, the polarization change area 41 changes a light beam of a particular linear polarization proceeding from the polarization beam splitter 15 of the optical path changer to a light beam of an orthogonally different linear polarization. Accordingly, the light beam passing through the polarization change area 41 and the light beam passing through the non-change area 43 have polarizations orthogonal to each other so as to not be correlated.

However, it is understood that aspects of the present invention are not limited to the half wave plate. For example, the polarization change area 41 can be alternatively operated as a random polarizer (i.e., a depolarizer). In this case, the light beam passing through the polarization change area 41, which operates as the random polarizer, and the light beam passing through the non-change area 43 may be not correlated.

When the polarization change area 41 is formed at the central portion of the polarization element 40 as described above, the polarization of the light beam passing through the polarization change area 41 and the polarization of the light beam not passing through the polarization change area 41 (i.e., passing through the non-change area 43) may be made to differ from each other.

The image at the right side of FIG. 2 shows the shape of the light beam passing through the polarization element 40 formed on the light receiving plane by tracing a light ray. To distinguish a light ray passing through the polarization change area 41 from other light rays, an area formed from the light ray passing through the polarization change area 41 is indicated as a blank area in the light receiving plane. The light beam (the signal beam) reflected from the signal layer passes through the detection lens 18 (such as an astigmatism lens) and forms a light beam within a focal length while the light beams reflected from the adjacent layer are dispersed. As can be seen in FIG. 2, the polarization state of the light beam in most of the area, except for the inner area of the signal beam, may be different from that of the light beam reflected from the adjacent layer (i.e., the noise beam). Thus, the value of cos θ in Equation 5 or 6 above may be reduced. The value of cos θ may become zero when the polarization states of the light beam passing through the polarization change area 41 and the non-change area 43 are orthogonal to each other. Furthermore, the value of cos θ may be close to zero when the light beam passing through the polarization change area 41 is in a random polarization state. Thus, the interlayer interference noise can be removed or reduced.

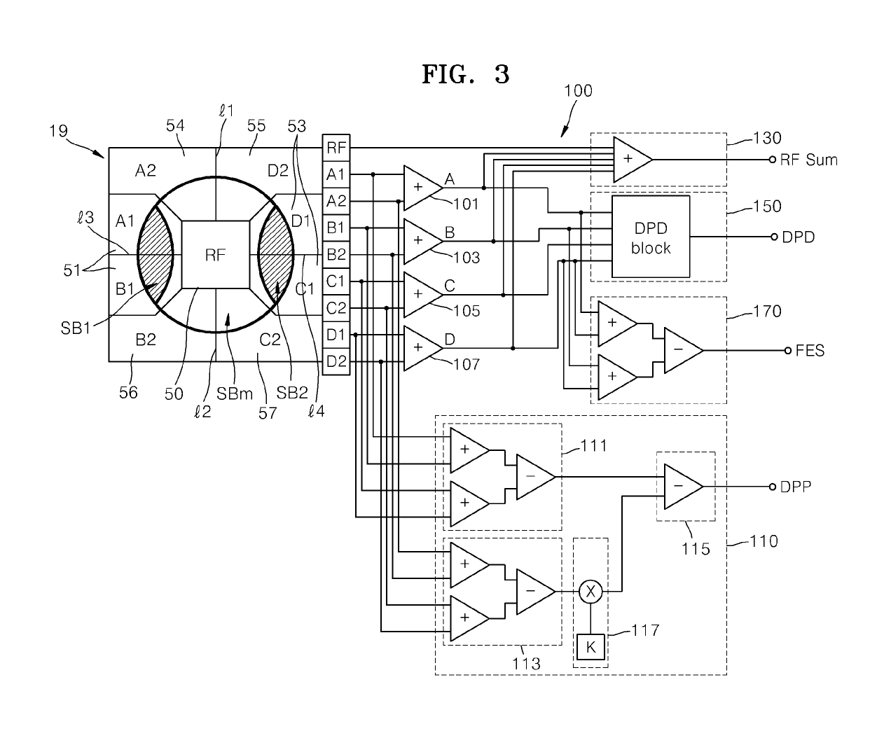

As described above, by providing the polarization element 40, the interference between the signal beam and the noise beam on the light receiving plane can be reduced. Meanwhile, although the interlayer interference noise can be reduced or removed by the polarization element 40, the effect of the interlayer interference may be not completely removed since the polarization state of the inner area of the signal beam still matches that of the noise beam reflected from the adjacent layer. Thus, to further remove or reduce the effect of the interlayer interference, the structures of the photodetector 19 and a signal detection circuit 100 (illustrated in FIG. 3) can be formed as in the following embodiments.

FIG. 3 illustrates the structure of the photodetector 19 and the signal detection circuit 100 according to an embodiment of the present invention. It is understood that, according to aspects of the present invention, an optical information storage medium system may include the optical pickup 10 as illustrated and described with reference to FIG. 1 and the signal detection circuit 100.

Referring to FIG. 3, the photodetector 19 includes a first light receiving portion 50 to detect a central portion of the non-overlap area SBm of the signal beam, a second light receiving portion 51 to detect a portion including the first overlap area SB1, a third light receiving portion 53 to detect a portion including the second overlap area SB2, fourth and fifth light receiving portions 54 and 55 to detect a remaining portion of the signal beam at one of the sides of the first through third light receiving portions 50, 51, and 53 such that the remaining portion is split by a first separation line l1, and sixth and seventh light receiving portions 56 and 57 to detect a remaining portion of the signal beam at the other sides of the first through third light receiving portions 50, 51, and 53 such that the remaining portion is split by a second separation line l2 aligned with the first separation line l1. The second, fourth, and sixth light receiving portions 51, 54, and 56 can be arranged in a row while the third, fifth, and seventh light receiving portions 53, 55, and 57 can be arranged in another row.

The second and third light receiving portions 51 and 53 may be respectively divided into two sections by third and fourth separation lines t3 and t4 aligned with each other and in a direction crossing the first and second separation lines t1 and t2. Thus, the photodetector 19 may have a nine sectioned structure as shown in FIG. 3. The width of the first light receiving portion 50 in a linear arrangement direction may be less than that of the second and third light receiving portions 51 and 53.

The signal detection circuit 100 may include a first tracking error signal detection portion 110 to detect, using a DPP method, a tracking error signal from detection signals of the second through seventh light receiving portions 51, 53, 54, 55, 56, and 57 of the photodetector 19. The signal detection circuit 100 may further include a reproduction signal detection portion 130 to detect an information reproduction signal by summing the detection signals of the first through seventh light receiving portions 50, 51, 53, 54, 55, 56, and 57. Moreover, the signal detection circuit 100 may even further include a focus error signal detection portion 170 detecting a focus error signal (FES) from the detection signals of the second through seventh light receiving portions 51, 53, 54, 55, 56, and 57. The signal detection circuit 100 may still further include a second tracking error signal detection portion 150 to detect a tracking error signal from the detection signals of the second through seventh light receiving portions 51, 53, 54, 55, 56, and 57 by using a differential phase detection method.

In the present embodiment, the first tracking error signal detection portion 110 includes a first operation unit 111, a second operation unit 113, and a third operation unit 115. The first operation unit 111 detects a first differential signal MPP′ (i.e., (A1+B1)−(C1+D1)) corresponding to a push-pull signal of the detection signals (A1, B1) and (C1, D1) of the second and third light receiving portions 51 and 53. The second operation unit 113 detects a second differential signal SPP′ (i.e., (A2+B2)−(C2+D2)) corresponding to a push-pull signal of a sum signal (A2+B2) of the detection signals A2 and B2 of the fourth and sixth light receiving portions 54 and 56 and a sum signal (C2+D2) of the detection signals D2 and C2 of the fifth and seventh light receiving portions 55 and 57. The third operation unit 115 detects a differential signal of the first and second differential signals MPP′ and SPP′ obtained from the first and second operation units 111 and 113 and generates a tracking error signal in a DPP method. Also, the first tracking error signal detection unit 110 may further include a gain control unit 117 that, for example, applies a predetermined gain k to the second differential signal SPP′ obtained from the second operation unit 113. In this case, a tracking error signal TES output from the third operation unit 115 may be MPP′−k·SPP′. The second operation unit 113 may correspond to a DC offset detection unit.

The reproduction signal detection portion 130 detects an information reproduction signal RF sum by summing all detection signals of the first through seventh light receiving portions 50, 51, 53, 54, 55, 56, and 57.

The first light receiving portion 50, located at the center of the nine-sectioned photodetector 19 illustrated in FIG. 3 is a portion where interlayer interference noise is generated as the polarizations of the signal beam and the light beam reflected from the adjacent layer are matched. Thus, a detection signal RF of the first light receiving portion 50 is not used to detect the tracking signal, and is used to detect the information reproduction signal RF sum.

The focus error signal detection portion 170 detects the focus error signal FES with a differential signal of a sum signal of the signals detected from the light receiving portions located in one diagonal direction and a sum signal of the signals detected from the light receiving portions located in the other diagonal direction of the second through seventh light receiving portions 51, 53, 54, 55, 56 and 57.

The second tracking error signal detection portion 150 is configured to detect a tracking error signal in a differential phase detection method. A differential phase signal is detected from a differential phase detection (DPD) block using the detection signals of the second through seventh light receiving portions 51, 53, 54, 55, 56, and 57, which are also used for the detection of the focus error signal FES as described above.

To detect the information reproduction signal RF sum, the focus error signal FES, and the differential phase signal DPD, a first sum signal (A1+A2) of the detection signals A1 and A2 of one of the split areas of the second light receiving portion 51 and the fourth light receiving portion 54 adjacent thereto, a second sum signal (B1+B2) of the detection signals B1 and B2 of the other one of the split areas of the second light receiving portion 51 and the sixth light receiving portion 56 adjacent thereto, a third sum signal (D1+D2) of the detection signals D1 and D2 of one of the split areas of the third light receiving portion 53 and the fifth light receiving portion 55 adjacent thereto, and a fourth sum signal (C1+C2) of the detection signals C1 and C2 of the other one of the split areas of the third light receiving portion 53 and the seventh light receiving portion 57 adjacent thereto are used.

Thus, the signal detection circuit 100 may include first through fourth adders 101, 103, 107, and 105 to detect the first through fourth sum signals ((A1+A2), (B1+B2), (D1+D2), and (C1+C2)) in the front end of the information reproduction signal detection portion 130, the focus error signal detection portion 170, and/or the second tracking error signal detection portion 150. In this case, at least one of the information reproduction signal RF sum, the focus error signal FES, and the differential phase signal DPD can be detected by using the first through fourth sum signals. When the first through fourth adders 101, 103, 107, and 105 are provided, the first through fourth sum signals may be input to the DPD block of the second tracking error signal detection portion 150.

As described above, according to aspects of the present invention, the interlayer interference noise can be firstly removed by changing the polarization state of the signal beam to be different from the polarization state of the noise beam reflected from the adjacent layer. Furthermore, the interlayer interference noise can be secondly removed by excluding the central portion of the signal beam in which the polarization states of the signal beam and the noise beam reflected from the adjacent layer are the same from the detection of a tracking error signal through the photodetector 19 and the signal detection circuit 100 as shown in FIG. 3.

Although the signal detection circuit 100 as described includes the first and second tracking error signal detection portions 110 and 150, the information reproduction signal detection portion 130, and the focus error signal detection portion 170, it is understood that aspects of the present invention are not limited thereto. For example, according to other aspects, the signal detection circuit 100 may include the first tracking error signal detection portion 110 and only a part of the other detection portions.

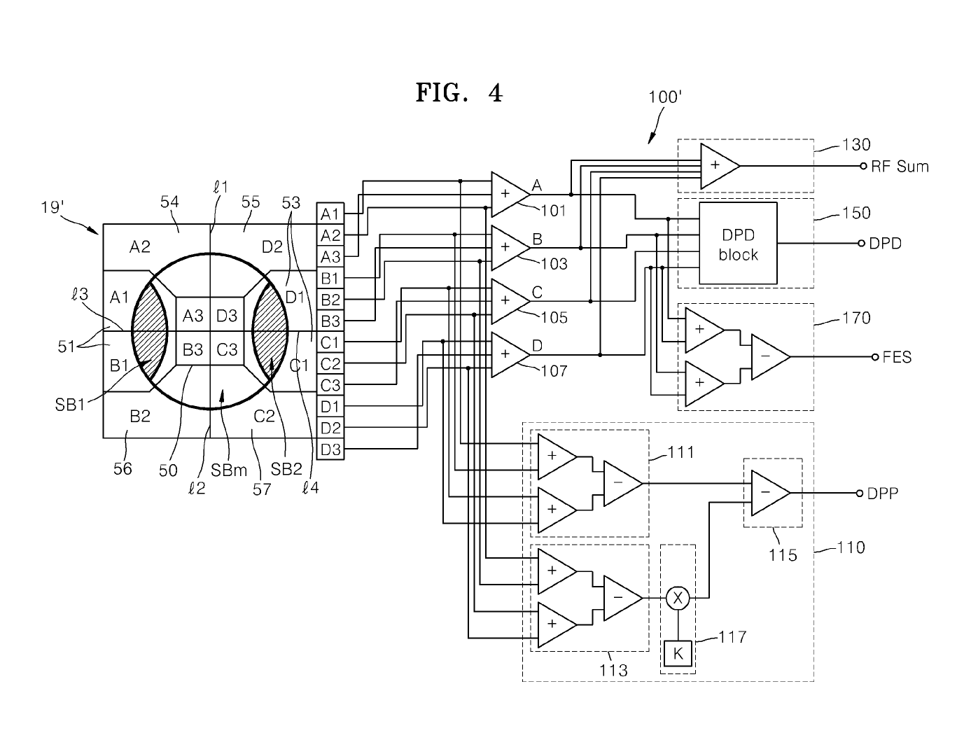

FIG. 4 illustrates the structure of a photodetector 19′ and a signal detection circuit 100′ according to another embodiment of the present invention. As compared to the embodiment illustrated in FIG. 3, the first light receiving portion 50 is divided into four sections and the signal detection circuit 100′ is changed.

Referring to FIG. 4, the first light receiving portion 50 of the photodetector 19 is divided into four sections by a separation line joining the first and second separation lines t1 and t2 and a separation line joining the third and fourth separation lines t3 and t4. Detection signals A3, B3, C3, and D3 of the first light receiving portion 50 may be used for detecting a tracking error signal by the DPD method and a focus error signal FES.

For example, the focus error signal FES can be detected from: the detection signals A1, A2, and A3 of one of the split areas of the second light receiving portion 51, the fourth light receiving portion 54 adjacent to the one of the split areas of the second light receiving portion 51, and a split area of the first light receiving portion 50 adjacent to the one of the split areas of the second light receiving portion 51 and the fourth light receiving portion 54; the detection signals B1, B2, and B3 of the other one of the split areas of the second light receiving portion 51, the sixth light receiving portion 56 adjacent to the other one of the split areas of the second light receiving portion 51, and a split area of the first light receiving portion 50 adjacent to the other one of the split areas of the second light receiving portion 51 and the sixth light receiving portion 56; the detection signals D1, D2, and D3 of one of the split areas of the third light receiving portion 53, the fifth light receiving portion 55 adjacent to the one of the split areas of the third light receiving portion 53, and a split area of the first light receiving portion 50 adjacent to the one of the split areas of the third light receiving portion 53 and the fifth light receiving portion 55; and the detection signals C1, C2, and C3 of the other one of the split areas of the third light receiving portion 53, the seventh light receiving portion 57 adjacent to the other one of the split areas of the third light receiving portion 53, and a split area of the first light receiving portion 50 adjacent to the other one of the split areas of the third light receiving portion 53 and the seventh light receiving portion 57.

Also, the second tracking error signal detection portion 150 performs the differential phase signal detection using the detection signals of the first through seventh light receiving portions 50, 51, 53, 54, 55, 56, and 57 used for the focus error signal FES detection.

As shown in FIG. 4, when the first through fourth adders 101, 103, 105, and 107 are provided, the first adder 101 obtains a sum signal (A1+A2+A3) of the detection signals A1, A2, and A3, the second adder 103 obtains a sum signal (B1+B2+B3) of the detection signals B1, B2, and B3, the third adder 105 obtains a sum signal (C1+C2+C3) of the detection signals C1, C2, and C3, and the fourth adder 107 obtains a sum signal (D1+D2+D3) of the detection signals D1, D2, and D3, respectively. Accordingly, the circuits of the information reproduction signal detection portion 130, the focus error signal detection portion 170, and the second tracking error signal detection portion 150 can be configured substantially the same as those of FIG. 3.

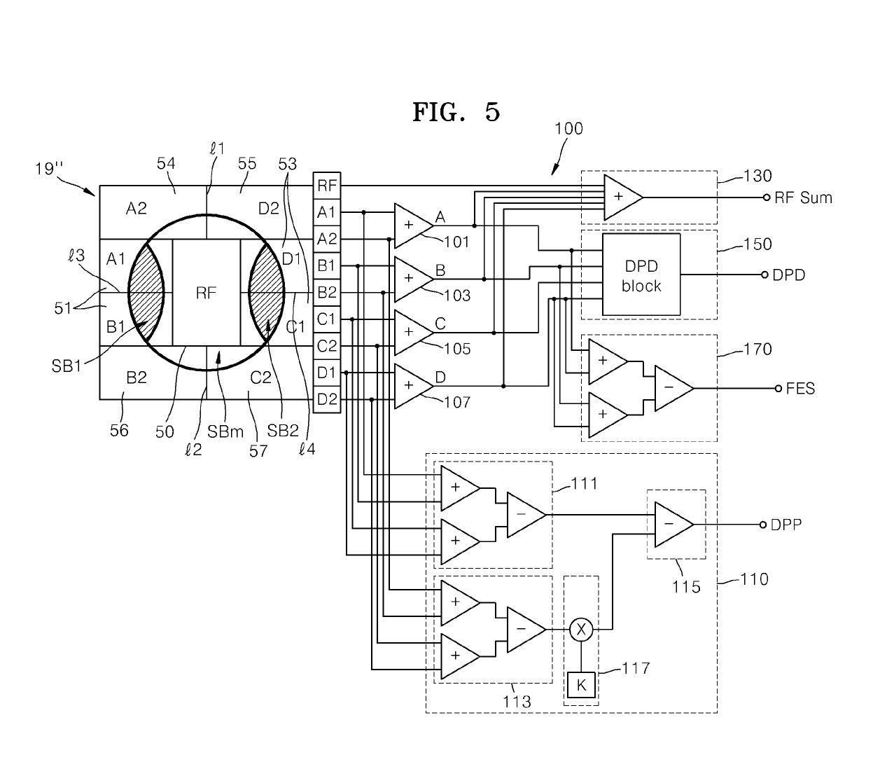

FIG. 5 illustrates the structure of a photodetector 19′ and the signal detection circuit 100 according to still another embodiment of the present invention. As compared to FIG. 3, though the circuit configuration is substantially the same, the width of the first light receiving portion 50 illustrated in FIG. 5 is longer in the linear arrangement direction. Referring to FIG. 5, the width of the first light receiving portion 50 is the same as the respective widths of the second and third light receiving portions 51 and 53. However, it is understood that aspects of the present invention are not limited thereto. For example, the width of the first light receiving portion 50 can be greater than the respective widths of the second and third light receiving portions 51 and 53.

In the light beam reflected from the optical information storage medium, the +1^{st} order diffractive beam and the −1^{st} diffractive beam overlap the 0^{th} order diffractive beam and a further higher order diffractive beam is generated at the central portion of the light beam having diffractive beam overlap areas with arc borders (like a baseball pattern, as illustrated in FIG. 2). When the width of the first light receiving portion 50 in the linear arrangement direction is increased, the higher order diffractive beam can be removed from the tracking error signal that is detected using the DPP method.

As described above, in the optical information storage medium system using a multilayer optical information storage medium 1, interlayer interference noise can be effectively removed so that tracking may be stabilized and one beam tracking may be possible by arranging a polarization element 40 on a light receiving path that can change the polarization of the central portion of the non-overlap area of the signal beam and by appropriately designing the photodetector 19 and the signal detection circuit 100.

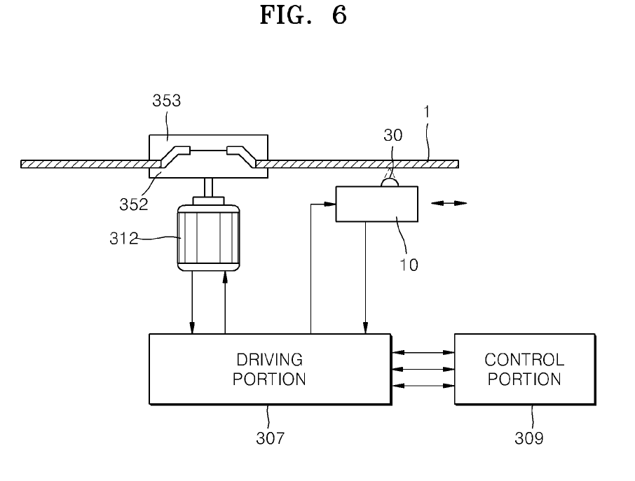

FIG. 6 illustrates the overall structure of an optical information storage medium system employing the optical pickup 10 according to an embodiment of the present invention. Referring to FIG. 6, the optical information storage medium system includes a spindle motor 312, the optical pickup 10, a driving portion 307, and a control portion 309. The spindle motor 312 rotates the optical information storage medium 1. The optical pickup 10 is movable in a radial direction of the optical information storage medium 1 to record and/or reproduce data to/from the optical information storage medium 1 according to the above-described various embodiments. The driving portion 307 drives the spindle motor 312 and the optical pickup 10. The control portion 309 controls focus and track servo of the optical pickup 10. In the embodiment illustrated in FIG. 6, the optical information storage medium system further includes a turntable 352 and a clamp 353 for chucking the optical information storage medium 1.

The light beam reflected from the optical information storage medium 1 is detected by the photodetector 19 provided in the optical pickup 10, opto-electrically converted to an electric signal, and operated in the signal detection circuit 100. The signal obtained from the signal detection circuit 100 is input to the control portion 309 via the driving portion 307. The driving portion 307 controls the rotation speed of the spindle motor 312, amplifies an input signal, and drives the optical pickup 10. The control portion 309 sends focus servo and tracking servo commands, adjusted based on the signal output from the driving portion 307, back to the driving portion 307 to implement the focusing and tracking operations of the optical pickup 10.

Although a few embodiments of the present invention has been particularly shown and described, it would be appreciated by those skilled in the art that changes may be made in this embodiment without departing from the principles and spirit of the present invention the scope of which is defined in the claims and their equivalents.

What is claimed is:

1. An optical pickup of a recording and/or reproducing apparatus that records and/or reproduces data to/from a multi-layer optical information storage medium, the optical pickup comprising:
a light source to emit a light beam;
an objective lens to focus the emitted light beam onto the optical information storage medium;
a polarization dependent optical path changer to transmit or to change a proceeding path of the light beam according to a polarization of the light beam;
a photodetector to detect a signal beam that is generated by a reflection of the focused light beam on a signal layer of the optical information storage medium; and
a polarization element provided on an optical path of the signal beam reflected from the optical information storage medium, passing through the objective lens, and proceeding toward the photodetector, to reduce an interference, on a light receiving plane, between the signal beam and a noise beam that is generated by a reflection of the light beam from an adjacent layer to the signal layer by changing a polarization state of the signal beam in at least a portion where the signal beam overlaps with the noise beam.

2. The optical pickup as claimed in claim 1, wherein the polarization element includes a polarization change area to change a polarization of a central portion of the signal beam.

3. The optical pickup as claimed in claim 2, wherein the polarization change area is a half wave plate or a random polarizer.

4. The optical pickup as claimed in claim 1, wherein:
the signal beam reflected from the optical information storage medium is diffracted into a 0^{th} order diffractive beam, a −1^{st} diffractive beam, and a +1^{st} diffractive beam;
the signal beam includes a first overlap area where the 0^{th} order diffractive beam and the +1^{st} order diffractive beam overlap, a second overlap area where the 0^{th} order diffractive beam and the −1^{st} order diffractive beam overlap separately from the first overlap area, and a non-overlap area formed of the 0^{th} order diffractive beam; and
the polarization element changes a polarization of the 0^{th} order diffractive beam passing through an area of the polarization element corresponding to a central portion of the non-overlap area of the signal beam.

5. The optical pickup as claimed in claim 4, wherein the polarization element includes a polarization change area in the area corresponding to the central portion of the non-overlap area of the signal beam to change the polarization of the 0^{th} order diffractive beam passing therethrough.

6. The optical pickup as claimed in claim 5, wherein the polarization change area is a half wave plate or a random polarizer.

7. The optical pickup as claimed in claim 4, wherein the photodetector comprises:
a first light receiving portion to detect the central portion of the non-overlap area of the signal beam;
a second light receiving portion to detect the first overlap area;
a third light receiving portion to detect the second overlap area;
fourth and fifth light receiving portions to detect a first remaining portion of the signal beam at a side of the first through third light receiving portions such that the first remaining portion of the signal beam is divided into two sections by a first separation line; and
sixth and seventh light receiving portions to detect a second remaining portion of the signal beam at another side of the first through third light receiving portions such that the second remaining portion of the signal beam is divided into two parts by a second separation line aligned with the first separation line,
wherein the second light receiving portion, the fourth light receiving portion, and the sixth light receiving portion are arranged in a first row and the third, fifth, and seventh light receiving portions are arranged in a second row.

8. The optical pickup as claimed in claim 7, wherein the second light receiving portion is divided into two sections by a third separation line, the third light receiving portion is divided into two sections by a fourth separation line, and the third and fourth separation lines cross the first and second separation lines so that the photodetector has a nine-sectioned structure.

9. The optical pickup as claimed in claim 8, wherein the first light receiving portion is divided into four sections by a separation line joining the first and second separation lines and a separation line joining the third and fourth separation lines.

10. The optical pickup as claimed in claim 7, wherein a width of the first light receiving portion in a linear arrangement direction is less than widths of the second and third light receiving portions.

11. The optical pickup as claimed in claim 7, wherein a width of the first light receiving portion in a linear arrangement direction is equal to or greater than widths of the second and third light receiving portions.

12. The optical pickup as claimed in claim 1, wherein the optical information storage medium is a Blu-ray disc.

13. A recording and/or reproducing apparatus to record and/or reproduce data to/from an optical information storage medium, the recording and/or reproducing apparatus comprising:
an optical pickup to record and/or reproduce the data to/from the optical information storage medium, the optical pickup comprising:
a light source to emit a light beam,
an objective lens to focus the emitted light beam onto the optical information storage medium,
a polarization dependent optical path changer to transmit or to change a proceeding path of the light beam according to a polarization of the light beam,
a photodetector to detect a signal beam that is generated by a reflection of the focused light beam on a signal layer of the optical information storage medium, and
a polarization element provided on an optical path of the signal beam reflected from the optical information storage medium, passing through the objective lens, and proceeding toward the photodetector, to reduce an interference, on a light receiving plane, between the signal beam and a noise beam that is generated by a reflection of the light beam from an adjacent layer to the signal layer by changing a polarization state of the signal beam in at least a portion where the signal beam overlaps with the noise beam.

14. The apparatus as claimed in claim 13, wherein the optical pickup is moveable in a radial direction of the optical information storage medium.

15. The apparatus as claimed in claim 13, further comprising:
a spindle motor to rotate the optical information storage medium;
a driving portion to drive the spindle motor and the optical pickup; and
a control portion to control focus and track servo of the optical pickup.

16. The apparatus as claimed in claim 13, wherein:
the signal beam reflected from the optical information storage medium is diffracted into a 0^{th} order diffractive beam, a −1^{st} diffractive beam, and a +1^{st} diffractive beam;
the signal beam includes a first overlap area where the 0^{th} order diffractive beam and the +1^{st} order diffractive beam overlap, a second overlap area where the 0^{th} order diffractive beam and the −1^{st} order diffractive beam overlap separately from the first overlap area, and a non-overlap area formed of the 0^{th} order diffractive beam; and
the polarization element changes a polarization of the 0^{th} order diffractive beam passing through an area of the polarization element corresponding to a central portion of the non-overlap area of the signal beam.

17. The apparatus as claimed in claim 16, wherein the polarization element includes a polarization change area in the area corresponding to the central portion of the non-overlap area of the signal beam to change the polarization of the 0^{th} order diffractive beam passing therethrough.

18. The apparatus as claimed in claim 17, wherein the polarization change area is a half wave plate or a random polarizer.

19. The apparatus as claimed in claim 16, wherein the photodetector comprises:
a first light receiving portion to detect the central portion of the non-overlap area of the signal beam;
a second light receiving portion to detect the first overlap area;
a third light receiving portion to detect the second overlap area;
fourth and fifth light receiving portions to detect a first remaining portion of the signal beam at a side of the first through third light receiving portions such that the first remaining portion of the signal beam is divided into two sections by a first separation line; and
sixth and seventh light receiving portions to detect a second remaining portion of the signal beam at another side of the first through third light receiving portions such that the second remaining portion of the signal beam is divided into two parts by a second separation line aligned with the first separation line,
wherein the second light receiving portion, the fourth light receiving portion, and the sixth light receiving portion are arranged in a first row and the third, fifth, and seventh light receiving portions are arranged in a second row.

20. The apparatus as claimed in claim 19, further comprising:
a tracking error signal detection portion to detect a tracking error signal from a detection signal of the photodetector of the optical pickup, the tracking error signal detection portion comprising:
a first operation unit to detect a first differential signal between detection signals of the second and third light receiving portions,
a second operation unit to detect a second differential signal between a sum signal of detection signals of the fourth and sixth light receiving portions and a sum signal of detection signals of the fifth and seventh light receiving portions, and
a third operation unit to detect a differential signal between the first and second differential signals obtained from the first and second operation units to generate the tracking error signal.

21. The apparatus as claimed in claim 20, further comprising a reproduction signal detection portion to detect an information reproduction signal by summing detection signals of the first through seventh light receiving portions.

22. The apparatus as claimed in claim 19, wherein the second light receiving portion is divided into two sections by a third separation line, the third light receiving portion is divided into two sections by a fourth separation line, and the third and fourth separation lines cross the first and second separation lines so that the photodetector has a nine-sectioned structure.

23. The apparatus as claimed in claim 22, further comprising:
a first tracking error signal detection portion to detect a tracking error signal from a detection signal of the photodetector of the optical pickup, the first tracking error signal detection portion comprising:
a first operation unit to detect a first differential signal between detection signals of the second and third light receiving portions,
a second operation unit to detect a second differential signal between a sum signal of detection signals of the fourth and sixth light receiving portions and a sum signal of detection signals of the fifth and seventh light receiving portions, and
a third operation unit to detect a differential signal between the first and second differential signals obtained from the first and second operation units to generate a first tracking error signal.

24. The apparatus as claimed in claim 23, further comprising a second tracking error signal detection portion to detect a second tracking error signal from the detection signal of the photodetector of the optical pickup,
wherein the second tracking error signal detection portion detects a differential phase signal from a sum signal of detection signals of a first divided section of the second light receiving portion and the fourth light receiving portion adjacent to the first divided section of the second light receiving portion, a sum signal of detection signals of a second divided section of the second light receiving portion and the sixth light receiving portion adjacent to the second divided section of the second light receiving portion, a sum signal of detection signals of a first divided section of the third light receiving portion and the fifth light receiving portion adjacent to the first divided section of the third light receiving portion, and a sum signal of detection signals of a second divided section of the third light receiving portion and the seventh light receiving portion adjacent to the second divided section of the third light receiving portion.

25. The apparatus as claimed in claim 23, further comprising a reproduction signal detection portion to detect an information reproduction signal by summing detection signals of the first through seventh light receiving portions.

26. The apparatus as claimed in claim 25, further comprising a focus error signal detection portion to detect a focus error signal from detection signals of a first divided section of the second light receiving portion and the fourth light receiving portion adjacent to the first divided section of the second light receiving portion, detection signals of a second divided section of the second light receiving portion and the sixth light receiving portion adjacent to the second divided section of the second light receiving portion, detection signals of a first divided section of the third light receiving portion and the fifth light receiving portion adjacent to the first divided section of the third light receiving portion, and detection signals of a second divided section of the third light receiving portion and the seventh light receiving portion adjacent to the second divided section of the third light receiving portion.

27. The apparatus as claimed in claim 26, further comprising a second tracking error signal detection portion to detect a differential phase signal using the detections signals of the second through seventh light receiving portions used to detect the focus error signal.

28. The apparatus as claimed in claim 27, further comprising first through fourth adders to obtain a first sum signal of the detection signals of the first divided section of the second light receiving portion and the fourth light receiving portion, a second sum signal of the detection signals of the second divided section of the second light receiving portion and the sixth light receiving portion, a third sum signal of the detection signals of a first divided section of the third light receiving portion and the fifth light receiving portion, and a fourth sum signal of the detection signals of the second divided section of the third light receiving portion and the seventh light receiving portion,
wherein at least one of the information reproduction signal, the focus error signal, and the differential phase signal is detected using the first through fourth sum signals.

29. The apparatus as claimed in claim 22, wherein the first light receiving portion is divided into four sections by a separation line joining the first and second separation lines and a separation line joining the third and fourth separation lines.

30. The apparatus as claimed in claim 29, further comprising:
a first tracking error signal detection portion to detect a first tracking error signal from a detection signal of the photodetector of the optical pickup;
a reproduction signal detection portion to detect an information reproduction signal; and
a focus error signal detection portion to detect a focus error signal, wherein:
the first tracking error signal detection portion comprises:
a first operation unit to detect a first differential signal between detection signals of the second and third light receiving portions;
a second operation unit to detect a second differential signal between a sum signal of detection signals of the fourth and sixth light receiving portions and a sum signal of detection signals of the fifth and seventh light receiving portions; and
a third operation unit to detect a differential signal between the first and second differential signals obtained from the first and second operation units to generate the first tracking error signal,
the reproduction signal detection portion detects the information reproduction signal by summing detection signals of the first through seventh light receiving portions, and
the focus error signal detection portion detects the focus error signal from detection signals of a first divided section of the second light receiving portion, the fourth light receiving portion adjacent to the first divided section of the second light receiving portion, and a first divided section of the first light receiving portion adjacent to the first divided section of the second light receiving portion and the fourth light receiving portion, detection signals of a second divided section of the second light receiving portion, the sixth light receiving portion adjacent to the second divided section of the second light receiving portion, and a second divided section of the first light receiving portion adjacent to the second divided section of the second light receiving portion and the sixth light receiving portion, detection signals of a first divided section of the third light receiving portion, the fifth light receiving portion adjacent to the first divided section of the third light receiving portion, and a third divided section of the first light receiving portion adjacent to first divided section of the third light receiving portion and the fifth light receiving portion, and detection signals of a second divided section of the third light receiving portion, the seventh light receiving portion adjacent to the second divided section of the third light receiving portion, and a fourth divided section of the first light receiving portion adjacent to the second divided section of the third light receiving portion and the seventh light receiving portion.

31. The apparatus as claimed in claim 30, further comprising a second tracking error signal detection portion to detect a differential phase signal using the detection signals of the first through seventh light receiving portions used to detect the focus error signal.

32. The apparatus as claimed in claim 31, further comprising first through fourth adders to obtain a first sum signal of the detection signals of the first divided section of the second light receiving portion, the fourth light receiving portion, and the first divided section of the first light receiving portion, a second sum signal of the detection signals of the second divided section of the second light receiving portion, the sixth light receiving portion, and the second divided section of the first light receiving portion, a third sum signal of the detection signals of the first divided section of the third light receiving portion, the fifth light receiving portion, and the third divided section of the first light receiving portion, and a fourth sum signal of the detection signals of the second divided section of the third light receiving portion, the seventh light receiving portion, and the fourth divided section of the first light receiving portion,
wherein at least one of the information reproduction signal, the focus error signal, and the differential phase signal is detected using the first through fourth sum signals.

33. The apparatus as claimed in claim 16, wherein a border between the first overlap area and the non-overlap area defines an arc on a first side of the signal beam and a border between the second overlap area and the non-overlap area defines an arc on a second side of the signal beam, opposite the first side.

34. An optical pickup of a recording and/or reproducing apparatus including an objective lens and a photodetector to record and/or reproduce data to/from a multi-layer optical information storage medium, the optical pickup comprising:
a polarization element provided on an optical path of a signal beam reflected from the optical information storage medium, passing through the objective lens, and proceeding toward the photodetector, to reduce an interference, on a light receiving plane, between the signal beam and a noise beam that is generated by a reflection from an adjacent layer to the signal layer by changing a polarization state of the signal beam in at least a portion where the signal beam overlaps with the noise beam.

35. The optical pickup as claimed in claim 34, wherein the polarization element includes a polarization change area to change a polarization of a central portion of the signal beam.

36. The optical pickup as claimed in claim 35, wherein the polarization change area is a half wave plate or a random polarizer.

37. The optical pickup as claimed in claim 34, wherein:
the signal beam reflected from the optical information storage medium is diffracted into a 0^{th} order diffractive beam, a −1^{st} diffractive beam, and a +1^{st} diffractive beam;
the signal beam includes a first overlap area where the 0^{th} order diffractive beam and the +1^{st} order diffractive beam overlap, a second overlap area where the 0^{th} order diffractive beam and the −1^{st} order diffractive beam overlap separately from the first overlap area, and a non-overlap area formed of the 0^{th} order diffractive beam; and
the polarization element changes a polarization of the 0^{th} order diffractive beam passing through an area of the polarization element corresponding to a central portion of the non-overlap area of the signal beam.

38. The optical pickup as claimed in claim 37, wherein the polarization element includes a polarization change area in the area corresponding to the central portion of the non-overlap area of the signal beam to change the polarization of the 0^{th} order diffractive beam passing therethrough.

39. A method of reducing an interference between a signal beam reflected from a signal layer of a multi-layer optical information storage medium and a noise beam reflected from an adjacent layer to the signal layer in a recording and/or reproducing apparatus including an objective lens and a photodetector to record and/or reproduce data to/from the multi-layer optical information storage medium, the method comprising:
changing a polarization state of the signal beam, after being reflected from the signal layer and before being detected by the photodetector, in at least a portion of the signal beam where the signal beam overlaps with the noise beam.
